(19) United States
(12) Patent Application Publication
(10) Pub. No.: US 2018/0154320 A1
(43) Pub. Date: Jun. 7, 2018

(54) MAGNETIC COUPLING AND STIRRING DEVICE WITH MAGNETIC COUPLING

(71) Applicant: IKA-Werke GmbH & CO. KG, Staufen (DE)

(72) Inventor: Peter Jägle, Ballrechten-Dottingen (DE)

(21) Appl. No.: 15/571,736

(22) PCT Filed: May 3, 2016
(86) PCT No.: PCT/EP2016/000721

§ 371 Date: Nov. 3, 2017

(30) Foreign Application Priority Data
May 7, 2015 (DE) 10 2015 005 736.7
May 2, 2016 (EP) PCT/EP2016/000711

(51) Int. Cl. B01F 13/08

(52) U.S. Cl. CPC B01F 13/0818; B01F 13/0827

(57) ABSTRACT

The aim of the invention is to reduce the overall height of a magnetic coupling (1) which is particularly suitable for use in a magnetic stirrer. For this purpose, at least one magnet (4) of the rotor (3), which magnet is designed as a driving magnet for a counter-coupling piece of the magnetic coupling, particularly for a stirring magnet of a magnetic stirrer, and is arranged such that it projects at least partially or completely into a space (7) encompassed by a rotor-stator unit (5) of the magnetic coupling (1) and/or projects at least partially or completely into said space (7).

This application is a National Stage Application under 35 U.S.C. § 371 of PCT Application No. PCT/EP2016/000721, filed May 3, 2016, which claims priority PCT Application No. PCT/EP2016/000711, filed May 2, 2016, and to German Patent Application No. 10 2015 005 736.7, filed May 7, 2015, the entire disclosures of which are hereby incorporated by reference.

The invention relates to a magnetic coupling, in particular for use in a magnetic stirrer or some other stirring device, with an electric motor comprising a rotor-stator unit, wherein at least one magnet, which is designed for driving a counter-coupling piece that is to be coupled with the magnetic coupling and has at least one counter magnet or comprises magnetic material, is arranged on a rotor of the rotor-stator unit, and with a stator, which has a number of induction coils.

Furthermore, the invention also relates to a stirring device, in particular a magnetic stirrer, with such a magnetic coupling.

Such magnetic couplings are used for example in the case of magnetic stirrers known from the prior art, but also other stirring devices, as a drive unit for contactlessly driving a usually rod-shaped stirring magnet, which can be placed into a vessel filled with medium to be stirred.

In this case, the at least one magnet arranged on the rotor of the electric motor carries the stirring magnet along with it as a counter-coupling piece and thus makes it possible for liquids to be mixed even in closed vessels. The at least one magnet of the rotor can therefore also be referred to as a driving magnet.

A magnetic couplings that are already known from the prior art, in particular those that are used in the case of magnetic stirrers, have proven to be successful. Depending on the application, however, it may be felt to be disadvantageous that the magnetic couplings that are already known from the prior art are of a comparatively great overall height, which is increased still further if the stirring device in which the magnetic coupling is fitted have additional elements, such as for example a heating device or the like, which should be arranged as close as possible to a placement area of the stirring device.

The object of the invention is therefore to provide a magnetic coupling and a stirring device, in particular a magnetic stirrer, of the type defined at the beginning that are in each case distinguished by a smaller overall axial height.

A magnetic coupling with the features of patent claim 1 is proposed to achieve this object. The object is achieved in particular by the at least one magnet of the rotor in the position for use reaching at least partially or completely into a space enclosed by the rotor-stator unit and/or being arranged at least partially or completely in this space.

In this way, a particularly shallow overall height of the magnetic coupling can be achieved, since the at least one magnet arranged on the rotor is arranged at least partially within the previously described space of the rotor-stator unit.

If a stator of the rotor-stator unit has a number of induction coils, which are arranged within the previously defined space, and the at least one magnet of the rotor in the position for use reach at least partially or completely into an intermediate space extending between the induction coils and/or are arranged at least partially or completely in this intermediate space, an even more compact magnetic coupling with an even smaller overall axial height can be provided.

A further reduction in the overall height of the magnetic coupling can be achieved if as an alternative or in addition thereto the rotor in the position for use reaches at least partially or completely into an intermediate space, for example into the already previously mentioned intermediate space extending between the induction coils of the stator, and/or is arranged at least partially or completely in this space.

It may be expedient in this case if a clear height of the space and/or of the intermediate space corresponds to a dimension of the induction coils of the stator that is measured in the direction of an axis of rotation of the rotor.

In the case of a particularly advantageous embodiment of the magnetic coupling according to the invention, it may be provided that the at least one magnet of the rotor has such a dimension that it fits completely into the space and/or intermediate space of the magnetic coupling. It is in this way possible that the at least one magnet of the rotor in the position for use is arranged within the space and/or the intermediate space of the magnetic coupling and preferably can be arranged in this space.

Furthermore, it may be provided that a height of the at least one magnet of the rotor is at most as great as a dimension of the induction coils of the stator, for example the previously already mentioned dimension measured in the direction of the axis of rotation of the rotor. This means that such a magnet of the stator can also in terms of its height fit into the intermediate space defined by the induction coils of the stator, since its height is no greater than the dimension of the induction coils measured in the direction of the axis of rotation of the rotor, the size of which may be decisive for the clear height of said space and/or intermediate space, and consequently decisive for the altogether for the accommodation of the rotor and its at least one magnet in the space and/or intermediate space.

In the case of a particularly advantageous embodiment of the invention, it may also be provided that an axial dimension or height of the rotor is at most as great as an axial dimension or height of the stator and/or that a radial dimension of the rotor is dimensioned such that the latter fits completely into the intermediate space between the induction coils. This allows a particularly compact magnetic coupling to be provided, since such a rotor can be arranged completely in the intermediate space between the induction coils of the stator and does not have to project beyond the stator in the axial direction.

It may be expedient if the rotor has at least two magnets, which in the position for use reach at least partially or completely into the space and/or into the intermediate space and/or are recessed in this space. With at least two magnets on the rotor, it is possible for a counter-coupling piece having at least one counter magnet to be reliably carried along and driven by the magnetic coupling.

It may be advantageous if the rotor has a depression for receiving the at least one magnet, in which the at least one magnet of the rotor is arranged in the position for use. In this way it is possible to integrate the at least one magnet of the rotor into the rotor and thus on the one hand minimize the overall height of the rotor and consequently also keep the overall height of the entire coupling as small as possible.

When using more than just one magnet on the rotor, it may be advantageous if the rotor has for each magnet of the rotor a depression of its own in each case. In the case of a preferred embodiment of the magnetic coupling according to the invention, these multiple depressions for multiple magnets of the rotor may then expediently be arranged uniformly distributed around an axis of rotation of the rotor, for example the already previously mentioned axis of rotation.

Furthermore, the rotor may be formed in a pot-shaped manner and the at least one magnet may be arranged at least partially or completely within a pot formed by the pot-shaped rotor. In this case, a depth of a pot of the pot-shaped rotor, for example the already previously mentioned pot, may be dimensioned such that the at least one magnet can be arranged or is arranged at least partially or completely recessed in the pot-shaped rotor. This therefore means that the at least one magnet in the case of such a rotor does not project beyond a pot rim of the rotor, but rather can preferably finish flush with it.

A particularly small overall height of the magnetic coupling can be achieved if the at least one magnet is arranged at least partially or even completely within the rotor and/or at least partially or completely between an upper side aligned transversely in relation to the axis of rotation of the rotor and an underside of the rotor aligned parallel thereto and/or transversely in relation to the axis of rotation of the rotor. The previously described underside of the rotor may be in particular a rotor base, which downwardly closes off the rotor in the position for use.

It may also be provided that the rotor has an annular magnet, by way of which the rotor can be driven by the induction coils of the stator, wherein the annular magnet may be arranged on the rotor such that it laterally encloses at least partially or completely the at least one magnet of the rotor.

In the case of a further advantageous embodiment of the invention, it may also be provided that the rotor has a rotor base, which is designed for intensifying a magnetic field of the at least one magnet of the rotor, therefore in this way for improving the magnetic coupling force of the magnetic coupling.

This may be of importance in particular if the magnetic coupling is used in the case of a magnetic stirrer that is used for processing and mixing particularly viscous media, for which a sufficiently great coupling force is required to avoid ripping off of the magnetic coupling.

It may also be provided that the magnetic coupling has a covering plate, in the position for use of the magnetic coupling may be arranged under the at least one rotor of the electric motor of the magnetic coupling together with the at least one magnet of the rotor. It is possible in this case that an outer side of this covering plate that is facing away from the rotor is formed as a placement area for a vessel.

In particular in the case of integration of the magnetic coupling into a magnetic stirrer, a particularly compact construction can be obtained, on the one hand of the magnetic coupling and on the other hand, and as a result thereof, also of the magnetic stirrer.

In this case, the covering plate of the magnetic coupling may consist of a sheet metal, in particular of high-grade steel. It is however also conceivable to provide a covering plate made of glass or of plastic. A covering plate produced from sheet metal, glass or plastic can help to provide a shallow type of construction of the magnetic coupling according to the invention, since such a covering plate can be kept very thin.

The magnetic coupling, in particular a covering plate of the magnetic coupling, for example the previously mentioned covering plate, may expediently have a heating device for heating a vessel placed on it.

In this case, the heating device may be arranged under a covering plate of the magnetic coupling, for example the already previously mentioned covering plate. The heating device may also comprise within a covering plate of the magnetic coupling, for example the already previously mentioned covering plate, heating wires let into or arranged under this covering plate. In addition or as an alternative thereto, it is also possible that the heating device has a heating coil, preferably a coated heating coil, which may expediently be arranged on an outer side of a covering plate of the magnetic coupling that serves as a placement area, for example the already previously mentioned covering plate.

If the magnetic coupling has a base plate arranged opposite from a covering plate of the magnetic coupling, for example the already previously mentioned covering plate, and formed as a printed circuit board, the base plate of the magnetic coupling may have a dual function:

On the one hand, it can thus close off the coupling and, on the other hand, it can be a carrier for circuit parts and/or sensors and/or conductor tracks, which in turn can help to provide the shallow type of construction of the magnetic coupling.

The magnetic coupling may have a covering plate, under and/or behind which at least the rotor of the electric motor of the magnetic coupling is arranged together with the at least one magnet of the rotor. Such a covering plate can close off at least on one side the space enclosed by the rotor-stator unit. Under and/or behind the covering plate, at least the rotor of the electric motor of the magnetic coupling can be arranged together with the at least one magnet of the rotor. Thus, the elements of the magnetic coupling that are arranged under and/or behind the covering plate can be protected from loss, damage and/or contamination, for example during transport of the magnetic coupling.

On an outer side of the magnetic coupling, in particular of the covering plate, that is facing away from the rotor, a placement device may be provided. Such a placement device may serve for placing a vessel, in particular a stirring vessel. In this case, the placement device may be a placement plate. The placement device, in particular the placement plate, may be at an axial distance from the magnetic coupling, in particular from the covering plate, or else also lie against the magnetic coupling, in particular the covering plate, or be in contact with it.

The magnetic coupling may be designed for coupling a counter-coupling piece arranged outside the space enclosed by the rotor-stator unit. For this purpose, the magnetic coupling may be assigned a counter-coupling piece, which is arranged outside the space enclosed by the rotor-stator unit. This provides a magnetic coupling of a particularly small overall height, in the space of which that is enclosed by the rotor-stator unit no counter-coupling piece is arranged. Therefore, this space can also be referred to as free of a counter-coupling piece. The magnetic coupling may comprise or have a counter-coupling piece that is arranged outside the space enclosed by the rotor-stator unit.

It is possible that the counter-coupling piece is at an axial distance from the rotor-stator unit and/or from the space enclosed by the rotor-stator unit. It is also conceivable that the counter-coupling piece can be coupled or is coupled axially with the magnetic coupling. In this way, an axial coupling can be created between the magnetic coupling and the counter-coupling piece. This differs from radial couplings in that here the counter-coupling piece is not arranged within the space enclosed by the rotor-stator unit and magnetic field lines form largely along an axis of rotation of the rotor-stator unit.

In the case of one embodiment of the invention, it may be provided that the counter-coupling piece is a stirring element of a stirring device, in particular of a magnetic stirrer, that is arranged outside the space enclosed by the rotor-stator unit. This may help to provide a small overall height of the stirring device, in particular of the magnetic stirrer. The stirring element may for example be a magnetic rod or stirring bar of a magnetic stirrer.

It may also be provided that the counter-coupling piece can be placed into a stirring vessel, in particular loosely, outside the space enclosed by the rotor-stator unit. It is however also possible that the counter-coupling piece is mounted movably with respect to a fixed element of a stirring device outside the space enclosed by the rotor-stator unit. In this case, the counter-coupling piece may for example be arranged rotatably mounted on a fixed spindle of the stirring device, in particular fitted onto such a spindle.

It should be pointed out that, in the context of the invention, the magnetic coupling according to the invention and the previously described counter-coupling piece can be understood and referred to altogether as a magnetic coupling. This applies in particular if the view is taken that in the case of the magnetic coupling according to the invention a magnetic coupling is specifically formed between the at least one magnet that is provided on the rotor of the magnetic coupling according to the invention and the counter-coupling piece, and a coupling must comprise at least one coupling element and one coupled element.

With the aid of the electric motor, the rotor and the at least one magnet that is arranged on the rotor, a torque generated by the electric motor can be transferred to the counter-coupling piece arranged outside the space enclosed by the rotor-stator unit, and thus the counter-coupling piece can be driven in a rotating manner.

In the case of the stirring device defined at the beginning, in particular if it is formed as a magnetic stirrer, the previously mentioned object is achieved by the magnetic coupling that is used in the stirring device being a magnetic coupling as claimed in one of claims 1 to 22.

In this way, the overall height of the stirring device, in particular of the magnetic stirrer, can be reduced, and consequently a particularly compact stirring device can be provided.

The stirring device may have a covering plate for covering the magnetic coupling. In this case, the covering plate may be at an axial distance from the magnetic coupling or in the position for use of the magnetic coupling lie against the magnetic coupling, in particular against a covering plate of the magnetic coupling.

An exemplary embodiment of the invention is described in more detail below on the basis of the drawing, in which, in a partly greatly schematized representation:

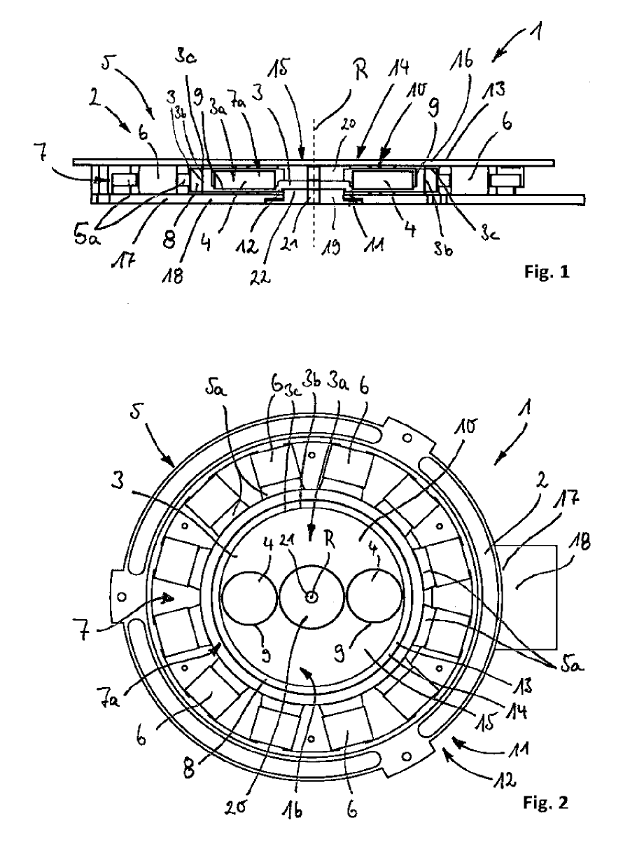

FIG. 1 shows a side view of a magnetic coupling according to the invention and

FIG. 2 shows a plan view of the magnetic coupling according to the invention that is represented in FIG. 1.

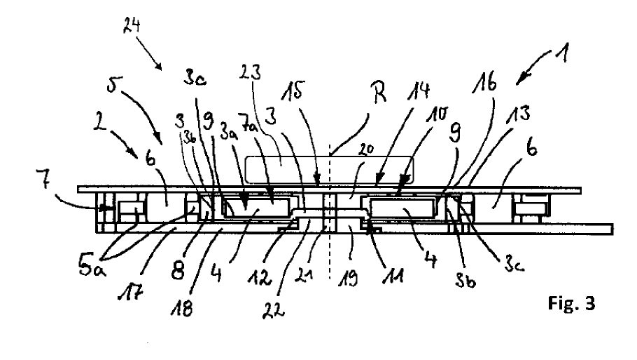

FIG. 3 shows a further side view of the magnetic coupling represented in FIGS. 1 and 2, with a counter-coupling piece in the form of a stirring magnet that in its position for use is arranged outside the space enclosed by the rotor-stator unit.

FIGS. 1, 2 and 3 show a magnetic coupling, which is denoted overall by 1 and is suitable in particular for use in a magnetic stirrer or else in some other stirring device that is not represented in the figures.

The magnetic coupling 1 has an electric motor 2 with a rotor-stator unit 5. The rotor-stator unit 5 has a rotor 3, on which in the present exemplary embodiment a total of two magnets 4 are arranged. The two magnets 4 are designed for driving a counter-coupling piece 23 to be coupled with the magnetic coupling 1, which counter-coupling piece has at least one counter magnet or comprises magnetic material, for example steel or ferrite, and is not represented in FIGS. 1 and 2. Such a counter-coupling piece 23 may for example be a stirring magnet, which is usually formed in a rod-shaped manner and is used together with a magnetic stirrer for thoroughly mixing media located in a vessel (see FIG. 3). The vessel may for this purpose be placed onto a placement area of the magnetic stirrer.

The figures show that the two magnets 4 of the rotor 3 in the position for use are arranged completely in a space 7 enclosed by the rotor-stator unit 5, and therefore upwardly project neither beyond the rotor 3 nor the stator 5a.

FIG. 1 in particular shows that the rotor 3 is formed in a pot-shaped manner and that the at least one magnet 4, in the present exemplary embodiment the two magnets 4, is/are arranged within the pot 3a formed by the rotor 3. In this case, the two magnets 4 are surrounded by a peripheral rotor wall 3b.

The rotor-stator unit 5 of the electric motor 2 also has a stator 5a with a total of twelve induction coils 6, which are all arranged within the space 7.

FIG. 2 in particular clearly shows that the induction coils 6 are arranged in such a way that between them there extends an intermediate space 7a, which the induction coils 6 define, delimit and surround. According to the position for use of these magnets 4 that is represented in FIG. 1, the two magnets 4 of the rotor 3 not only reach into this intermediate space 7a but are also arranged completely recessed in this space.

The side view of the magnetic coupling 1 according to FIG. 1 clearly shows that a clear height of the space 7 and also of the intermediate space 7a corresponds to a dimension of the induction coils 6 of the stator 5 that is measured in the direction of an axis of rotation R of the rotor 3. In other words, this means that the available clear height of the space 7 or of the intermediate space 7a between the induction coils 6 is as great as the height of the induction coils 6 of the stator 5 of the electric motor 2 of the magnetic coupling 1.

According to the figures, the rotor 3 of the electric motor 2 also has on its circumferential side facing the induction coils 6 in the position for use, which is an outer side of the peripheral rotor wall 3b, an annular magnet 8. The annular magnet 8 surrounds the pot-shaped rotor 3 and has a number of magnetic poles corresponding to the number of induction coils 6, for example twelve to 16 poles, into which the annular magnet 8 is divided.

The annular magnet 8 makes it possible that the rotor 3 can be driven with the aid of a magnetic rotary field generated by the induction coils 6 of the stator 5.

Both figures show that the two magnets 4 of the rotor 3 have a certain dimension in each case, so that the two together fit completely into the space 7. Both figures also show that the two magnets 4 of the rotor 3 in the position for use are arranged completely within this space 7.

This is possible because the two magnets 4 of the rotor 3 have a height that are at most as great as the dimension of the induction coils 6 of the stator 5 that is measured in the direction of the axis of rotation R of the rotor 3. In other words, this means that the magnets 4 of the rotor 3 that are represented in the figures have a somewhat smaller height than the induction coils 6 of the stator 5.

As a result, the two magnets 4 of the rotor 3 in the position for use can reach completely into the space 7 of the magnetic coupling 1 and be recessed in this space.

Since the clear height of the intermediate space 7a between the induction coils 6 is also decisively determined by their height, the two magnets 4 also fit into the intermediate space 7a and can also be arranged completely recessed in this space.

It should be pointed out at this stage that the intermediate space 7a lies completely within the space 7 enclosed by the rotor-stator unit 5 and is surrounded by this space.

In the present exemplary embodiment of the magnetic coupling 1, a depth of the pot 3a formed by the rotor 3 is dimensioned such that the at least one magnet 4, here the two magnets 4, is/are arranged completely recessed in the pot 3a of the rotor 3 and in the position for use does/do not project beyond a pot rim 3c.

It can also be seen from the figures that an axial dimension or height of the rotor 3 is at most as great as an axial dimension or height of the stator 5a. A radial dimension of the rotor 3 is dimensioned such that the latter fits completely into the intermediate space 7a between the induction coils 6 and is arranged in this space. This allows a very compact magnetic coupling 1 to be provided.

Both figures show that the rotor 3 has for each of the two magnets 4 a depression 9 in each case, which serve for receiving the two magnets 4. It is clear from the position for use represented in the two figures that each of the two magnets 4 of the rotor 3 in a position for use is arranged in one of the two depressions 9 in each case that are present in the rotor 3.

According to FIG. 1, it is clear that each of the two magnets 4 is in this case arranged in the interior of the depressions 9 of the rotor 3 that are assigned to them. The two depressions 9 in the rotor 3 serve the purpose of being able to define the position of the magnets 4 and fix them better on the rotor 3.

The depressions 9 have in this case a depth that corresponds to only about one tenth of the height of the magnets 4. This means that about nine tenths or more of the magnets 4 are not arranged within the depressions 9, but are free. This is favorable for the function of the magnetic coupling 1, since in this way a magnetic shielding of the magnets 4 by the depressions 9 can be prevented.

According to FIG. 2, the two depressions 9 are in this case arranged uniformly distributed, distributed about the axis of rotation R of the rotor 3. Since in the case of the present exemplary embodiment there are only two depressions 9 for a total of two magnets 4 of the rotor 3, they are logically positioned on the rotor 3 offset by 180° in relation to one another and at the same distance from the axis of rotation R of the rotor 3. The side view according to FIG. 1 shows that the two magnets 4 are arranged within the rotor 3 and between an upper side 10 aligned transversely in relation to the axis of rotation R of the rotor 3 and an underside 11 of the rotor 3 aligned parallel thereto and likewise transversely in relation to the axis of rotation R of the rotor 3.

In the case of the exemplary embodiment of the magnetic coupling 1 that is represented in FIGS. 1 and 2, the upper side 10 of the rotor 3 is defined by the upper pot rim 3c of the rotor 3.

The underside 11 is in this case formed by a rotor base denoted by 12.

The rotor base 12 of the rotor 3 is designed for intensifying a magnetic field of the two magnets 4 of the rotor 3 in order to improve the coupling effect of the magnetic coupling 1.

The magnetic coupling 1 also has a covering plate 13, under which in the position for use of the magnetic coupling 1 at least the rotor 3 of the electric motor 2 of the magnetic coupling 1 is arranged together with the two magnets 4 of the rotor 3. In this case, an outer side 14 of the covering plate 13 that is facing away from the rotor 3 is formed as a placement area 15 for a vessel.

Depending on the embodiment of the magnetic coupling 1, said covering plate 13 of the magnetic coupling 1 may in this case consist of a sheet metal, in particular of high-grade steel, or of glass or of plastic, and thus be formed particularly thin, which in turn helps to provide the compact form of construction of the magnetic coupling.

The magnetic coupling 1 also has a heating device 16 for heating a vessel placed on the covering plate 13. This heating device 16 may in this case be connected to the covering plate 13 of the magnetic coupling 1 or be integrated in it.

In the case of one embodiment of the magnetic coupling 1, it is provided that the heating device 16 is arranged under the covering plate 13 of the magnetic coupling 1. In this case, the heating device 16 comprises heating wires that are let into the covering plate 13 or arranged under the covering plate 13 and not represented in the figures.

In the case of another embodiment of the magnetic coupling 1, the heating device 16 has a heating coil, preferably a coated heating coil, which is arranged on the outer side 14 of the covering plate 13 that serves as a placement area 15. It goes without saying that it is also possible to arrange this heating coil within the covering plate 13 or under the covering plate 13.

The magnetic coupling 1 also has a base plate 17 arranged opposite from the covering plate 13 of the magnetic coupling 1 and formed as a printed circuit board 18 for further reducing the overall height of the magnetic coupling 1. This allows the base plate 17 to be assigned a dual function, in that, on the one hand, it downwardly closes off the magnetic coupling 1 and, on the other hand, it acts as a carrier for circuit parts and/or sensors and/or conductor tracks.

FIG. 3 illustrates that the magnetic coupling 1 is designed for coupling the counter-coupling piece 23 arranged outside the space 7 enclosed by the rotor-stator unit 5 and for driving it in the desired way with the aid of the electric motor 2. For this purpose, the counter-coupling piece 23 is assigned to the magnetic coupling 1. The rotating movement that the rotor 3 and its magnets 4 undergo during the operation of the magnetic coupling 1 allows the counter-coupling piece 23 counter-coupling piece 23 coupled with the magnets 4 to be driven in a rotating manner and made to rotate in the desired way.

The counter-coupling piece 23 is at an axial distance from the rotor-stator unit 5 and from the space 7 enclosed by the rotor-stator unit. In this case, the counter-coupling piece 23 can be coupled or is coupled axially with the magnetic coupling 1 and can be driven with the aid of the electric motor 2. It can also be said in this case that a magnetic coupling is created between the two magnets 4 and the counter-coupling piece 23.

The fact that the counter-coupling piece 23 is arranged outside the space 7 enclosed by the rotor-stator unit 5 and at an axial distance from it means that a so-called axial coupling is created between the magnetic coupling 1, in particular between the magnets 4 of the rotor 3 of the magnetic coupling 1, and the counter-coupling piece 23.

The counter-coupling piece 23 represented in FIG. 3 is a stirring element of a stirring device 24, here a stirring magnet or stirring rod or stirring bar of a magnetic stirrer, arranged outside the space 7 enclosed by the rotor-stator unit 5. In this case, the counter-coupling piece 23 can be placed loosely into a stirring vessel not represented in the figures outside the space 7 enclosed by the rotor-stator unit 5 and can be driven by means of the magnetic coupling 1. In the case of an exemplary embodiment of the invention not represented in the figures, the counter-coupling element 23 may also be a stirring element that is mounted movably with respect to a fixed element of the stirring device 24 outside the space 7 enclosed by the rotor-stator unit 5. In this case, the counter-coupling piece 23 may for example be arranged rotatably mounted on a fixed spindle of the stirring device, in particular fitted onto such a spindle.

The magnetic coupling 1 represented in the figures may be integrated in various stirring devices that are not represented in the figures. Particularly advantageously, the magnetic coupling 1 may in this case be integrated into a magnetic stirrer that is likewise not represented in the figures and thus provide a magnetic stirrer of a reduced overall height.

The figures also show that the rotor 3 is mounted rotatably about a spindle 21 in the rotor-stator unit 5 by means of a first, lower bearing 19 and a second, upper bearing 20. The rotor 3 in this case rests with a lowered middle portion 22 on the lower bearing 19. In the position for use, the upper bearing 20 rests on the middle portion 22. The spindle 21 is inserted through a bore in each case in the rotor 3 and in the two bearings 19 and 20. The two bearings 19 and 20 are formed as sliding bearings, but in the case of another exemplary embodiment of the magnetic coupling 1 may also be formed as rolling bearings.

The magnetic coupling 1 according to the invention and the counter-coupling piece 23 may also be referred to together as a magnetic coupling unit. This then comprises the magnetic coupling 1 and the counter-coupling piece 23 that can be coupled with it, which is arranged outside the space 7 enclosed by the rotor-stator unit 5.

The stirring device 24 may in this case have the magnetic coupling unit. In an embodiment of the stirring device 24 according to the invention that is not represented in the figures, the stirring device has a coupling plate for covering the magnetic coupling 1. The covering plate may be at an axial distance from the magnetic coupling 1 or in the position for use of the magnetic coupling 1 lie against the magnetic coupling 1.

For reducing the overall height of the magnetic coupling 1, which is suitable in particular for use in a magnetic stirrer, the at least one magnet 4 of the rotor 3, which acts as a driving magnet for a counter-coupling piece of the magnetic coupling, in particular for a stirring magnet of a magnetic stirrer, is arranged in such a way that it projects at least partially or completely into the space 7 enclosed by the rotor-stator unit 5 and/or is arranged at least partially or completely in this space 7.

1. A magnetic coupling (1), in particular for use in a magnetic stirrer or some other stirring device, with an electric motor (2) comprising a rotor-stator unit (5), wherein at least one magnet (4), which is designed for driving a counter-coupling piece that is to be coupled with the magnetic coupling (1) and has at least one counter magnet or comprises magnetic material, is arranged on a rotor (3) of the rotor-stator unit (5), wherein the at least one magnet (4) of the rotor (3) in the position for use reaches at least partially or completely into a space (7) enclosed by the rotor-stator unit (5) and/or is arranged at least partially or completely in this space.

2. The magnetic coupling (1) as claimed in claim 1, wherein a stator (5a) of the rotor-stator unit (5) has a number of induction coils (6), which are arranged within the space (7), and in that the at least one magnet (4) of the rotor (3) and/or the rotor (3) in the position for use reach at least partially or completely into an intermediate space (7a) extending between the induction coils (6) and/or are arranged at least partially or completely in this space.

3. The magnetic coupling (1) as claimed in claim 2, wherein a clear height of the space (7) and/or of the intermediate space (7a) corresponds to a dimension of the induction coils (6) of the stator (5) that is measured in the direction of an axis of rotation (R) of the rotor (3).

4. The magnetic coupling (1) as claimed in claim 2, wherein the at least one magnet (4) of the rotor (3) has such a dimension that it fits completely into the space (7) and/or into the intermediate space (7a) of the magnetic coupling (1), in particular in that a height of the at least one magnet (4) is at most as great as an axial dimension or height of the stator (5) and/or at most as great as a dimension or height of the induction coils (6) measured in the direction of the axis of rotation (R).

5. The magnetic coupling (1) as claimed in claim 2, wherein an axial dimension or height of the rotor (3) is at most as great as an axial dimension or height of the stator (5a) and/or in that a radial dimension of the rotor (3) is dimensioned such that the latter fits completely into the intermediate space (7a) between the induction coils (6).

6. The magnetic coupling (1) as claimed in claim 2, wherein the rotor (3) has at least two magnets (4), which in the position for use reach at least partially or completely into the space (7) and/or into the intermediate space (7a) and/or are recessed in this space.

7. The magnetic coupling (1) as claimed in claim 1, wherein the rotor (3) has a depression (9) for receiving the at least one magnet (4), in which the at least one magnet (4) of the rotor (3) is arranged in the position for use, and/or in that the rotor (3) has for each magnet (4) of the rotor (3) a depression (9) of its own in each case, preferably wherein multiple depressions (9) for multiple magnets (4) of the rotor (3) are arranged uniformly distributed around the axis of rotation (R) of the rotor (3).

8. The magnetic coupling (1) as claimed in claim 1, wherein the rotor (3) is formed in a pot-shaped manner and the at least one magnet (4) is arranged at least partially or completely within a pot (3a) formed by the rotor (3), preferably wherein a depth of the pot (3a) formed by the pot-shaped rotor (3) is dimensioned such that the at least one magnet (4) can be arranged or is arranged at least partially or completely recessed in the pot (3a).

9. The magnetic coupling (1) as claimed in claim 1, wherein the at least one magnet (4) is arranged at least partially or completely within the rotor (3) and/or at least partially or completely between an upper side (10) aligned transversely in relation to the axis of rotation (R) of the rotor (3) and an underside (11), in particular of a rotor base (12), of the rotor (3) aligned parallel thereto and/or transversely in relation to the axis of rotation (R) of the rotor (3).

10. The magnetic coupling (1) as claimed in claim 1, wherein the rotor (3) has an annular magnet (8), by way of which the rotor (3) can be driven by the induction coils (6) of the stator (5a), wherein the annular magnet (8) is arranged on the rotor (3) such that it laterally encloses at least partially or completely the at least one magnet (4) of the rotor (3).

11. The magnetic coupling (1) as claimed in claim 1, wherein the rotor (3) has a rotor base (12), which is designed for intensifying a magnetic field of the at least one magnet (4) of the rotor (3).

12. The magnetic coupling (1) as claimed in claim 1, wherein the magnetic coupling (1) has a covering plate (13), under which in the position for use of the magnetic coupling (1) at least the rotor (3) of the electric motor (R) of the magnetic coupling (1) is arranged together with the at least one magnet (4) of the rotor (3), wherein an outer side (14) of the covering plate (13) that is facing away from the rotor (3) is formed as a placement area (15) for a vessel.

13. The magnetic coupling (1) as claimed in claim 12, wherein the covering plate (13) of the magnetic coupling (1) consists of a sheet metal, in particular of high-grade steel, or of glass or of plastic.

14. The magnetic coupling (1) as claimed in claim 12, wherein the covering plate (13) of the magnetic coupling (1) has a heating device (16) for heating a vessel placed on it.

15. The magnetic coupling (1) as claimed in claim 14, wherein the heating device (16) is arranged under the covering plate (13) of the magnetic coupling (1) and/or in that the heating device (16) comprises heating wires let into the covering plate (13) or arranged under the covering plate (13) and/or in that the heating device (16) has a heating coil, preferably a coated heating coil, which is arranged on an outer side (14) of the covering plate (13) of the magnetic coupling (1) that serves as a placement area (15).

16. The magnetic coupling (1) as claimed in claim 12, wherein the magnetic coupling (1) has a base plate (17) arranged opposite from the covering plate (13) of the magnetic coupling (1) and formed as a printed circuit board (18), in particular on which circuit parts and/or sensors and/or conductor tracks are arranged.

17. The magnetic coupling (1) as claimed in claim 1, wherein the magnetic coupling (1) has a covering plate (13), under and/or behind which at least the rotor (3) of the electric motor (R) of the magnetic coupling (1) is arranged together with the at least one magnet (4) of the rotor (3).

18. The magnetic coupling (1) as claimed in claim 17, wherein on an outer side (14) of the magnetic coupling (1), in particular of the covering plate (13), that is facing away from the rotor (3), a placement device, preferably a placement plate, is provided for placing a vessel.

19. The magnetic coupling (1) as claimed in claim 1, wherein the magnetic coupling (1) is designed for coupling a counter-coupling piece (23) arranged outside the space (7) enclosed by the rotor-stator unit (5) and/or in that the magnetic coupling (1) is assigned a counter-coupling piece (23), in particular in that the magnetic coupling (1) comprises or has a counter-coupling piece (23), which is arranged outside the space (7) enclosed by the rotor-stator unit (5).

20. The magnetic coupling (1) as claimed in claim 19, wherein the counter-coupling piece (23) is at an axial distance from the rotor-stator unit (5) and/or from the space (7) enclosed by the rotor-stator unit (5) and/or in that the counter-coupling piece (23) can be coupled or is coupled axially with the magnetic coupling (1).

21. The magnetic coupling (1) as claimed in claim 19, wherein the counter-coupling piece (23) is a stirring element of a stirring device (24), in particular of a magnetic stirrer, that is arranged outside the space (7) enclosed by the rotor-stator unit (5).

22. The magnetic coupling (1) as claimed claim 19, wherein the counter-coupling piece (23) can be placed into a stirring vessel, in particular loosely, outside the space (7) enclosed by the rotor-stator unit (5) and/or is mounted movably with respect to a fixed element of a stirring device (24) outside the space (7) enclosed by the rotor-stator unit (5).

23. A stirring device (24), in particular a magnetic stirrer, with a magnetic coupling (1) as claimed in claim 1.

24. The stirring device (24) as claimed in claim 23, wherein the stirring device (24) has a covering plate for covering the magnetic coupling (1), wherein the covering plate is at an axial distance from the magnetic coupling (1) or in the position for use of the magnetic coupling (1) lies against the magnetic coupling (1).
